(19) United States
(12) Patent Application Publication
(10) Pub. No.: US 2004/0065771 A1
(43) Pub. Date: Apr. 8, 2004

(54) Aircraft wheels having vanes

(76) Inventor: Arnold J. Snyder, Charles, MO (US)

Correspondence Address: Henry W. Cummings, 3313 W. Adams St., St. Charles, MO, 63301, US

(21) Appl. No.: 10/263,427

(22) Filed: Oct. 3, 2002

(51) Int. Cl. B64C 27/22; B64C 39/00

(52) U.S. Cl. 244/10

(57) ABSTRACT

The present invention utilizes a new aircraft tire or wheel which employs specially shaped vanes protruding from the tire or wheel. These vanes capture the slipstream, and cause the tire and wheel to rotate in the direction of aircraft travel. Another embodiment of the invention employs a ring with cast or molded vanes, which may be mounted to the wheel of existing landing gear without changing to the new type of tire. The desired rotational speed of the tire will determine the number, size, and shape of the vanes, as well as how far they are mounted from the rotational axis of the tire/wheel combination.

### FIELD OF THE INVENTION

This invention relates to aircraft hardware, specifically to aircraft wheels having vanes.

### BACKGROUND OF THE INVENTION

The tires of all aircraft, particularly large, heavy, fast aircraft, are subjected to high levels of stress during landings. Modern jetliners land at speeds in excess of 150 miles per hour, and since the wheels are not turning prior to touching the runway, aircraft tires experience very heavy forces as they come into contact with the ground. High performance military aircraft can land at even greater speeds.

During landing, an aircraft tire goes from zero to over about 150 miles per hour in a very short period of time, causing it to initially “skid” as its rotational speed matches the ground speed of the aircraft. This causes the tire to lose rubber, shortening tread life. This rubber loss is often sporadic, resulting in flat spots on tires.

In addition, the burned tire material can contribute to air pollution.

The present invention provides a simple method and lightweight structure to induce rotation to aircraft wheels prior to touchdown.

### SUMMARY OF THE INVENTION

### OBJECTS OF THE INVENTION

One object of the present invention is to provide a mehod to impart rotational velocity to aircraft wheels prior to touchdown, while the aircraft is still flying.

Another object of the present invention is to provide structure to impart rotational velocity to aircraft wheels prior to touchdown, while the aircraft is still flying.

Other objects will be apparent from the following Descriptions and Drawings.

### SUMMARY

The preferred embodiment of the present invention utilizes a new aircraft tire, which employs specially shaped vanes protruding from the tire sidewalls. These vanes capture the slipstream, and cause the tire and wheel to rotate in the direction of aircraft travel.

Another embodiment of the invention employs a ring with cast or molded vanes, which may be mounted to on the wheels of existing landing gear without changing to the new type of tire. The desired rotational speed of the tire will determine the number, size, and shape of the vanes, as well as how far they are mounted from the rotational axis of the tire/wheel combination. Due to the nature of this invention, it is only suitable for use on aircraft with retractable landing gear.

### THE DRAWINGS

FIG. 1A is a perspective view of an airplane having landing gear wheels embodying the present invention.

FIG. 1 is a perspective view of a preferred embodiment of the present invention.

FIG. 2 is a close up perspective view of a vane.

FIG. 3 is a perspective view of a second embodiment of the present invention.

FIG. 4 is a perspective view of another vane.

### DESCRIPTION OF PREFERRED EMBODIMENTS

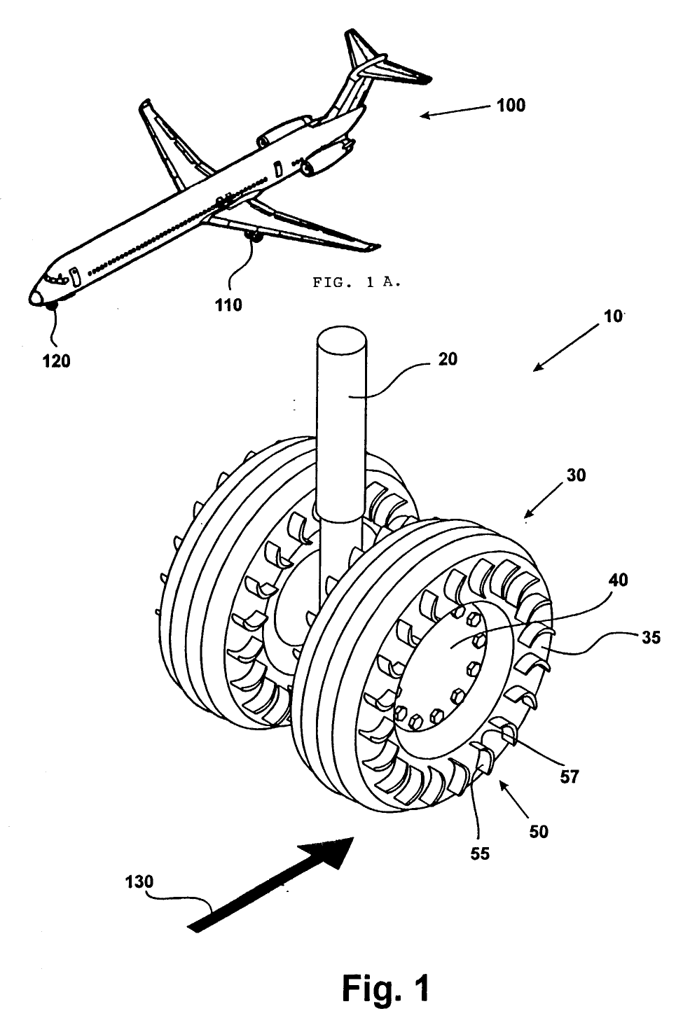

In accordance with the present invention, FIG. 1A shows a perspective view of a typical jet aircraft 100 utilizing main landing gear 110 and nose landing gear 120.

As shown in FIG. 1, the landing gear 120 has a strut 20, wheels 40, and tires 30 mounted on the wheels in a conventional manner. In the preferred embodiment, each tire 30 has a plurality of vanes 50 molded into its sidewall 35. The number, size, shape, and placement of the vanes will be determined by the particular aircraft and its landing characteristics.

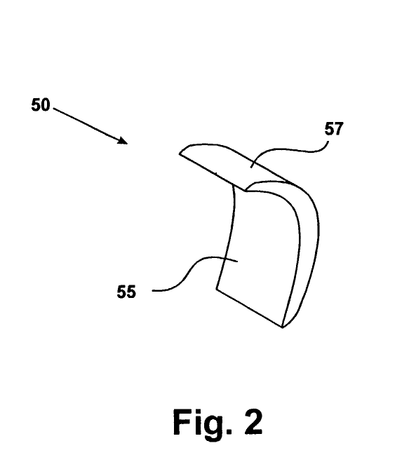

As shown in FIG. 2, each vane 50 comprises a windward face 55 and a leeward face 57.

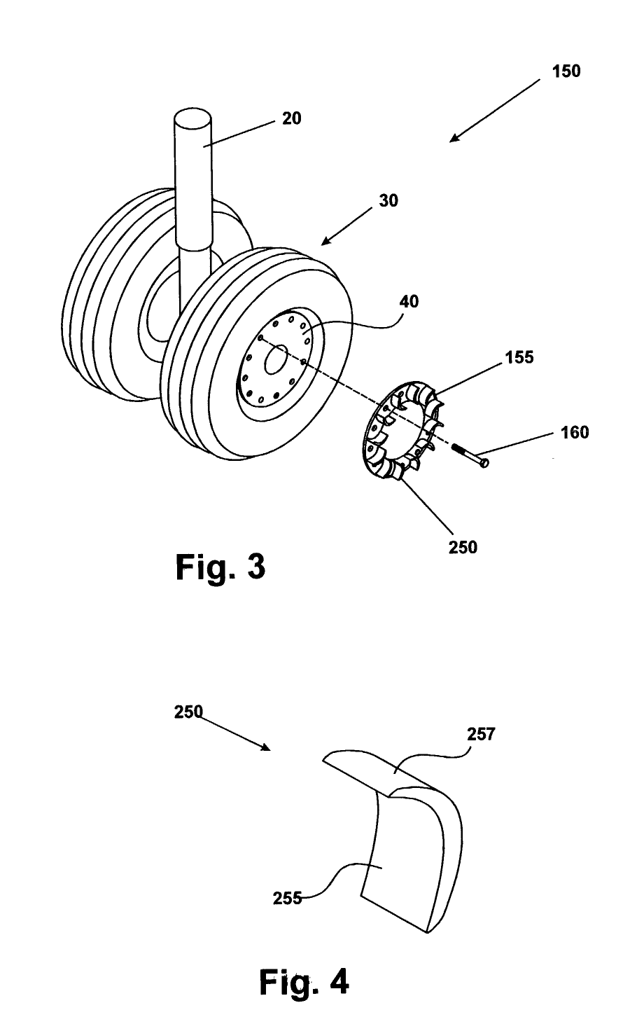

FIG. 3 shows a second embodiment of the present invention generally at 150. Rather than utilize a new tire, ring 155 is attached to wheel 40 by means of bolts 160. Ring 155 is made of aluminum alloy, titanium alloy, steel or other durable material, and comprises a plurality of vanes 250 around its perimeter. As previously stated, the final number, size, shape, and placement of the vanes will be determined by the particular aircraft, and its landing characteristics.

More vanes may be needed in this embodiment due to their relative closer proximity to the axis of rotation, and resulting lack of mechanical advantage. Each vane 250 comprises a windward face 255 and a leeward face 257.

In operation, as the aircraft approaches the airport, its landing gear are lowered, introducing the wheels and tires into the slipstream. Due to the cupped shape of windward face 55, 255, the bottom of the tire begins rotating in the direction of the wind, as shown by arrow 130 in FIG. 1, in a direction caused by the direction of movement of the aircraft. Because leeward face 57, 257 is convex rather than cupped, it is not as affected by the slipstream.

This reduces or avoids the tendency of the tires to lose rubber, and shorten tread life. It also reduces or eliminates the tendency of rubber loss and the formation of flat spots on the tires. In addition, the tendency of burned tire material to contribute to air pollution is reduced.

The invention is preferably used on aircraft with retractable landing gear to avoid the wheels rotating throughout the flight and requiring additional power and fuel to operate the aircraft.

What is claimed is:

1. An aircraft wheel spinning device comprising:
vanes molded to the tire sidewall.

2. An aircraft wheel spinning device comprising:
at least one ring having a pluarilty of vanes connected to said the aircraft wheel.

3. An aircraft wheel spinning device according to claim 1 comprising a plurality of vanes molded to an aircraft tire.

4. An aircraft wheel spinning device according to claim 3 wherein each said vane comprises a windward face and a leeward face.

5. An aircraft wheel spinning device according to claim 2 wherein each said vane comprises a windward face and a leeward face.

6. An aircraft wheel spinning device according to claim 4 wherein said windward face is designed with a cupped or concave surface to catch the slipstream.

7. An aircraft wheel spinning device according to claim 5 wherein said windward face is designed with a cupped or concave surface to catch the slipstream.

8. An aircraft wheel spinning device according to claim 6 wherein said leeward face is designed with a convex surface to allow the slipstream to pass by without affecting tire rotation.

9. An aircraft wheel spinning device according to claim 7 wherein said leeward face is designed with a convex surface to allow the slipstream to pass by without affecting tire rotation.

10. An aircraft wheel spinning device according to claim 4 wherein the exact size, shape, quantity, and placement of said vanes will be determined by the desired rotational speed of the tire.

11. An aircraft wheel spinning device according to claim 5 wherein the exact size, shape, quantity, and placement of said vanes will be determined by the desired rotational speed of the tire.

12. An aircraft wheel spinning device according to claim 8 wherein the exact size, shape, quantity, and placement of said vanes will be determined by the desired rotational speed of the tire.

13. An aircraft wheel spinning device according to claim 9 wherein the exact size, shape, quantity, and placement of said vanes will be determined by the desired rotational speed of the tire.

14. An aircraft wheel spinning device according to claim 2 wherein said ring comprises a plurality of vanes around its perimeter.

15. An aircraft wheel spinning device according to claim 14 wherein said ring is made of metal, aluminum alloy, titanium alloy, steel or other durable material.

16. An aircraft wheel spinning device according to claim 15 wherein said ring is designed to be mounted to an existing aircraft wheel by means of bolts.

17. An aircraft wheel spinning device according to claim 16 wherein each said vane comprises a windward face and a leeward face.

18. An aircraft wheel spinning device according to claim 17 wherein said windward face is designed with a cupped or concave surface to catch the slipstream.

19. An aircraft wheel spinning device according to claim 18 wherein said leeward face is designed with a convex surface to allow the slipstream to pass by without affecting tire rotation.

20. An aircraft wheel spinning device according to claim 19 wherein the exact size, shape, quantity, and placement of said vanes will be determined by the desired rotational speed of the tire.
